(19) United States
(12) Patent Application Publication
(10) Pub. No.: US 2024/0042694 A1
(43) Pub. Date: Feb. 8, 2024

(54) METHOD FOR CONSTRUCTING A 3D LABEL AND 3D LABEL THUS OBTAINED

(71) Applicant: FONDATION B-COM, CESSON SEVIGNE (FR)

(72) Inventors: Albert MURIENNE, RENNES (FR); Laurent LAUNAY, CHANTEPIE (FR)

(21) Appl. No.: 18/258,792

(22) PCT Filed: Dec. 17, 2021
(86) PCT No.: PCT/EP2021/086457

§ 371 Date: Jun. 21, 2023

(30) Foreign Application Priority Data
Dec. 22, 2020 (FR) FR2013922

(51) Int. Cl. B29C 64/386

(52) U.S. Cl. CPC B29C 64/386; B33Y 50/00

(57) ABSTRACT

A method for constructing a 3D label from a precursor element and the 3D label are provided, the precursor element including at least one surface, the method including: determining at least one 2D representation associated with the at least one surface of the precursor element, the 2D representation comprising a plurality of values associated with parts of the surface of the precursor element, respectively, and constructing a corresponding section of the 3D label from the surface by attaching a structural feature of an element of the respective section, defining said element from the surface according to a value of the 2D representation associated with the respective part of the surface.

### TECHNICAL FIELD OF THE INVENTION

The present invention relates to the technical field of object detection in a three-dimensional environment.

It relates in particular to a method for constructing a three-dimensional marker, intended for example to be used for detecting an object pose, and an associated three-dimensional marker.

### STATE OF THE ART

The detection of an object, and in particular its three-dimensional pose (defined by six degrees of freedom, three degrees of rotation and three degrees of translation) in an environment, finds a particular application with the development of augmented reality technologies. Object detection is for example extremely useful for the three-dimensional tracking of tools in a medical context.

For that purpose, it is known to benefit from the detection of a two-dimensional marker placed on the object the pose of which is to be determined. However, when the object is moved, the marker may no longer be visible, in which case it loses its interest for determining the object pose.

It is also known from the article “An Inertial and Optical Tracking System Using Low-Cost Commodity Parts” by A. Ahres and J. Schukken to place these two-dimensional markers on the faces of a cube.

However, in certain situations, for example in case of poor lighting (whether it is a sub-lighting or an over-lighting), detection problems may be encountered. To avoid this type of problem, it is possible to use depth cameras and to rely on the analysis of three-dimensional clouds of points. This allows in particular to avoid the drawbacks linked to a poor lighting or to color variations. Another solution, based on the use of only a depth sensor, is described in the following document: “μ-MAR: Multiplane 3D Marker based Registration for Depth-sensing Cameras” by M. Saval-Calvo, J. Azorin-Lopez, A. Fuster-Guillo and H. Mora-Mora. In this context, the object pose determination is for example allowed by positioning the object at the center of an arrangement of several cubes according to a chosen configuration.

However, the use of this solution is cumbersome due to the placement of the object at the center of the arrangement of several cubes. This method for determining the object pose from these three-dimensional markers is then not easy to implement, in particular for objects such as those used in the surgical world.

### DISCLOSURE OF THE INVENTION

In this context, the present invention proposes to improve the construction of markers intended to be used to determine the pose of an object on which the marker is attached.

More particularly, it is proposed according to the invention a method for constructing a three-dimensional marker from a precursor element, said precursor element having at least one surface, said method comprising steps of:
determining at least one two-dimensional representation associated with said at least one surface of the precursor element, said two-dimensional representation comprising a plurality of values respectively associated with parts of the surface of said precursor element, and
constructing a corresponding section of said three-dimensional marker from said surface by setting a structural feature of an element of the respective section, defining this element from said surface, as a function of a value of the two-dimensional representation associated with the respective part of said surface.

Thus, the use of a two-dimensional representation and the section construction from this two-dimensional representation makes it possible to obtain a three-dimensional marker having shape differences and asymmetries. These structural features of the three-dimensional marker then allow an optimized determination of the pose of an object to which the marker is attached, in particular because they allow an accurate identification when the three-dimensional marker is rotated or moved (with the object to which it is attached).

Moreover, advantageously, thanks to this construction method, the dimensions of the three-dimensional marker can be adapted to the dimensions of the object the pose of which is to be determined.

Other non-limiting and advantageous features of the construction method according to the invention, taken individually or according to all the technically possible combinations, are the following:
said precursor element having a plurality of faces,
said determination step comprises determining a plurality of two-dimensional representations respectively associated with some at least of said faces of the precursor element, each two-dimensional representation comprising a plurality of values respectively associated with parts of the respective face of said precursor element, and
said construction step comprises, for each face of said precursor element associated with a two-dimensional representation, constructing a corresponding section of said three-dimensional marker from said face by setting the structural feature of an element of the respective section, defining this element from said face, as a function of a value of the two-dimensional representation associated with the respective part of said face;
the plurality of two-dimensional representations is determined in such a way as to so maximize a determined distance between the two-dimensional representations associated with two juxtaposed faces of said precursor element;
said structural feature of the respective section element is the height of this element relative to said surface;
the setting of the structural feature of the respective section element corresponds to a height increase or a height decrease with respect to said part of the precursor element surface;
the two-dimensional representation comprises a series of first values and a series of second values, at least one first value being different from a second value, the height increase being associated with said series of first values and the height decrease being associated with said series of second values;
the height increase or the height decrease is implemented for a randomly determined part of the precursor element surface;
the three-dimensional marker being designed to cooperate with an acquisition system, the height increase or decrease depends on the accuracy parameters of said acquisition system;
each section of said three-dimensional marker being formed of a plurality of elements, the respective heights of the plurality of elements of the section are determined as a function of the different values of the two-dimensional representation, respectively;
the plurality of values of the two-dimensional representation is randomly determined;
the two-dimensional representation is a matrix representation;
the two-dimensional representation comprises binary values;
the first values are equal to 1 and the second values are equal to 0;
it is also provided a step of constructing a system for mechanical attachment of the three-dimensional marker; and
the mechanical attachment system is positioned on an apex of the three-dimensional marker corresponding to the intersection of several faces of the precursor element.

The present invention also relates to a three-dimensional marker obtained by a construction method as introduced hereinabove.

Of course, the different features, alternatives and embodiments of the invention can be associated with each other according to various combinations, insofar as they are not mutually incompatible or exclusive.

### DETAILED DESCRIPTION OF THE INVENTION

Moreover, various other features of the invention will be apparent from the appended description made with reference to the drawings that illustrate non-limiting embodiments of the invention, and wherein:

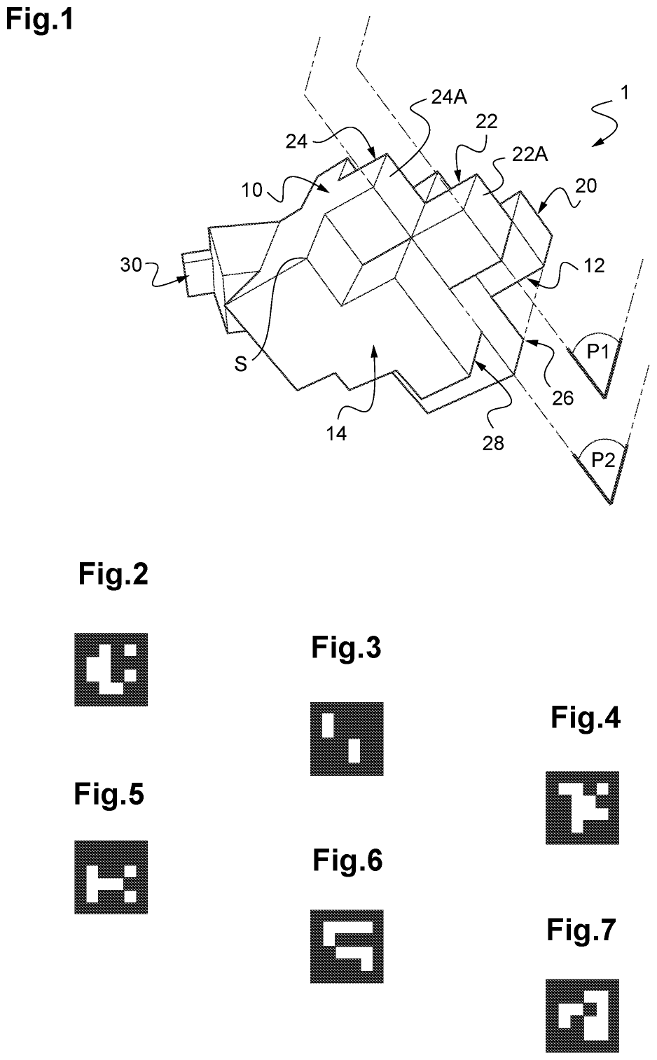

FIG. 1 shows a three-dimensional marker according to the invention,

FIG. 2 is a first example of a two-dimensional representation used in the construction method according to the invention,

FIG. 3 is a second example of a two-dimensional representation used in the construction method according to the invention,

FIG. 4 is a third example of a two-dimensional representation used in the construction method according to the invention,

FIG. 5 is a fourth example of a two-dimensional representation used in the construction method according to the invention,

FIG. 6 is a fifth example of a two-dimensional representation used in the construction method according to the invention,

FIG. 7 is a sixth example of a two-dimensional representation used in the construction method according to the invention,

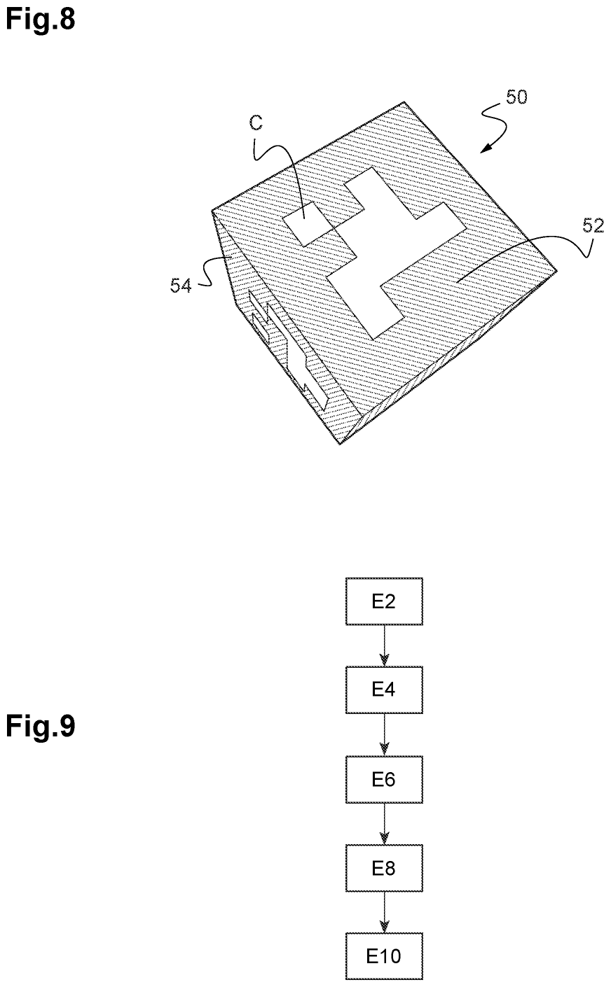

FIG. 8 shows the six two-dimensional representations of FIGS. 2 to 7 positioned on the faces of a cube-shaped precursor element,

FIG. 9 shows, as a flowchart, an example of a three-dimensional marker construction method according to the invention,

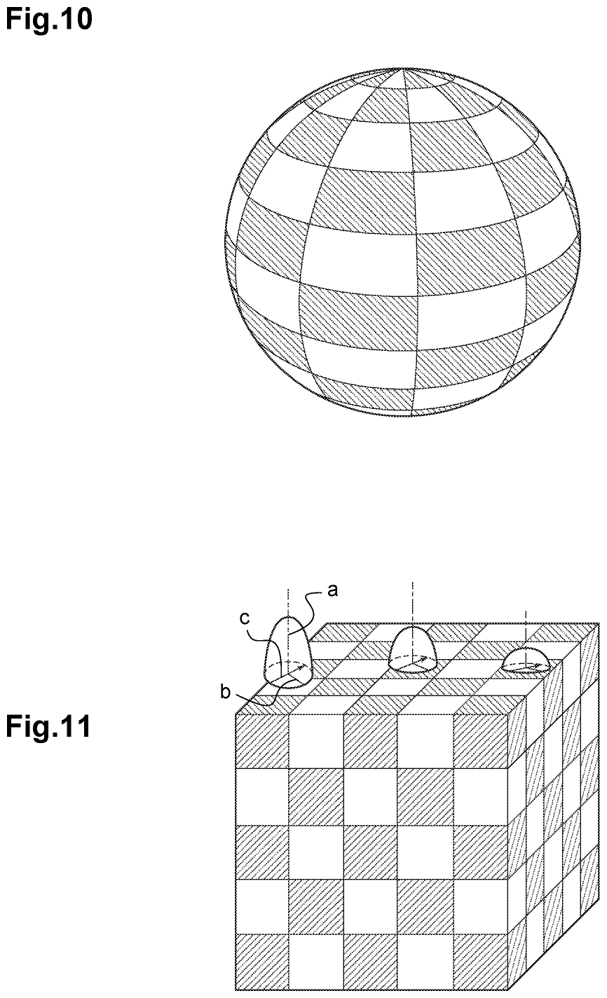

FIG. 10 shows an example of partitioning of the surface of a sphere-shaped precursor element, and

FIG. 11 shows an alternative of construction of the three-dimensional marker in the case of a cube-shaped precursor element.

FIG. 1 shows a three-dimensional marker 1.

This three-dimensional marker 1 comprises a plurality of sections, including the sections 10, 12, 14 visible in FIG. 1. Each section 10, 12, 14 comprises a plurality of elements 20, 22, 24, 26, 28. In the present description, the word “section” is used to describe a portion of the three-dimensional marker from one face of a precursor element as introduced hereinafter. The term “section” is used in order to include the notion of relief intrinsic to the three-dimensional marker construction method according to the invention. Moreover, the term “element” is used here to mean a small element of volume, for example here of cubic shape, belonging to the respective section.

As shown in FIG. 1, on each section, the parallel faces of the elements 20, 22, 24, 26, 28 are located in distinct parallel planes. For example, the face 24A of element 24 is set back from the face 22A of element 22. Face 22A is included in a plane P1 and face 24A is located in a plane P2. Planes P1 and P2 are parallel and spaced apart by a distance d (non zero).

As shown in FIG. 1, the three-dimensional marker 1 also comprises a mechanical attachment system 30. This mechanical attachment system 30 is intended to allow attachment of the three-dimensional marker 1 to an object (not shown) the three-dimensional pose of which is to be determined (using in particular the three-dimensional marker, as explained hereinafter).

According to a preferred embodiment, the mechanical attachment system 30 can be positioned on an apex of the three-dimensional marker 1. An apex of the three-dimensional marker 1 is defined as the point of intersection of several sections of the three-dimensional marker 1. For example, in FIG. 1 is shown an apex S at the intersection of sections 10, 12, 14. As an alternative, the attachment system can be positioned at another place of the three-dimensional marker, for example at the center of a section or an edge of the three-dimensional marker.

This three-dimensional marker 1 is for example intended to be used to determine the three-dimensional pose of an object. For that purpose, it is designed to cooperate with an acquisition system (not shown) adapted to acquire data relating to the environment of this object. The acquisition system is characterized by accuracy parameters such as, here, depth data. The acquisition system is for example a three-dimensional camera or a depth sensor.

The three-dimensional marker 1 described hereinabove is obtained by a construction method described hereinafter.

FIG. 9 is a flowchart showing an example of method for constructing the three-dimensional marker 1 as described hereinabove. This construction method is for example implemented due to the execution of a computer program by a processor (not shown).

As shown in FIG. 9, the construction method starts at step E2 of providing a precursor element. The precursor element comprises at least one surface. The precursor element is for example a sphere or a polyhedron.

In the case where the precursor element is a polyhedron, the precursor element comprises a plurality of surfaces corresponding to a plurality of faces of the polyhedron. In the example of FIG. 8, the precursor element is a cube whose plurality of surfaces is formed by the six faces of the cube.

The construction method continues with step E4. During this step, the processor determines a two-dimensional representation associated with a surface of the precursor element. More particularly here, in the example of the cubic precursor element, the processor determines a plurality of two-dimensional representations. These two-dimensional representations are respectively associated with at least some faces of the precursor element.

Each two-dimensional representation is for example a matrix representation. The size of the matrix representation can here be function of the accuracy parameters of the acquisition system.

The plurality of two-dimensional representations is for example determined in a random manner.

As an alternative, the plurality of two-dimensional representations can be determined in a semi-random manner in such a way that the two-dimensional representations associated with juxtaposed faces of the precursor element are not too similar. For example, the plurality of two-dimensional representations can be determined in such a way as to maximize a determined distance between the two-dimensional representations associated with two juxtaposed faces of the precursor element. The determined distance is for example a quadratic distance determined between the respective two-dimensional representations.

Each two-dimensional representation comprises a plurality of values. Each value of this plurality of values is associated with a part of the corresponding face of the precursor element. According to a possible embodiment, this plurality of values can be divided into two categories: a series of first values and a series of second values. A first value is different from a second value.

For example, each two-dimensional representation comprises binary values. The series of first values thus comprises here values equal to 1 and the series of second values comprises values equal to 0.

According to another example, the two-dimensional representation comprises real values. The series of first values thus comprises positive values and the series of second values comprises negative values.

FIGS. 2 to 7 show examples of two-dimensional representations. In these two-dimensional representations, it has been considered, by convention, that the white areas are associated with the series of second values and that the black areas are associated with the series of first values.

As shown in FIG. 9, the construction method continues with step E6. During this step, each two-dimensional representation determined at step E4 is associated with at least one face of the precursor element. For example, as shown in FIG. 9, each two-dimensional representation shown in FIGS. 2 to 7 is placed opposite one of the faces of the cube-shaped precursor element 50.

Here, the two-dimensional representation of FIG. 4 is associated with an upper face 52 of the cube-shaped precursor element 50. The two-dimensional representation of FIG. 2 is associated with a lateral face 54 of the cube-shaped precursor element 50.

By cutting each face of the precursor element 50 into different parts (in other words, by partitioning each face of the precursor element 50), the association of each face with a two-dimensional representation allows allocating a value (contained in the two-dimensional representation) to each part of the respective face.

In the example of FIG. 8, the different parts of each face of the precursor element are of square shape (as for example the part C visible in FIG. 8) and have the same size. Each part corresponding to a white area of the two-dimensional representation is associated with the series of second values. Each part corresponding to a black area of the two-dimensional representation is associated with the series of first values.

At step E8, at least one section of the three-dimensional marker 1 is constructed from the above-mentioned surface of the precursor element. Here, for each face of the precursor element, an associated section is constructed.

For that purpose, for each face of the precursor element, it is proceeded to a height setting of the element forming part of the section of the three-dimensional marker associated with each part of the respective face (e.g. associated with each square in the example of FIG. 8).

By height setting, it is meant a change of height of the respective face part with respect to the plane containing the initial face of the precursor element in such a way as to form a part of the three-dimensional marker section. The height determination depends for example of the accuracy parameters associated with the acquisition system used to determine the three-dimensional pose of the studied object.

This height change is for example constant over the whole respective part of the face. As an alternative, the height change can be made according to a profile that varies over the respective face part.

Here, the height setting of the element forming part of the three-dimensional marker section corresponds to a height increase or a height decrease of the respective face part with respect to the plane containing the respective face of the precursor element.

This height change is function of the value of the two-dimensional representation associated with the respective face part.

For example, here, a height increase is made for the parts of each face of the precursor element that are associated with the series of first values. They are for example values equal to 1 in the case of a binary two-dimensional representation. A height reduction is thus made for the parts of each face of the precursor element that are associated with the series of second values (e.g. values equal to 0 in the case of a binary two-dimensional representation). In practice, here, in the case of a cube-shaped precursor element of 5 centimeter (cm) side, the height displacement is typically of the order of 1 cm.

In practice, the height value increase or decrease can depend on the accuracy parameters of the acquisition system.

Finally, as shown in FIG. 1, each section 10, 12, 14 of the three-dimensional marker 1 is formed of a plurality of elements of different heights, each height depending on the value included in the two-dimensional representation associated with the face of the corresponding precursor element.

As an alternative, another structural feature than the height defining the element from the corresponding face of the precursor element could be used. For example, the structural feature could be a shape of the element; different shapes (e.g. planar element or spherical element or ellipse-shaped element) can then be respectively allocated to different elements according to the two-dimensional representation values associated with these different elements.

For example, the element can be defined in such a way to have a regular shape such as a regular tetrahedron or also a volume having an axis of revolution. This type of structural feature has for advantage to simplify the design and manufacture of the three-dimensional marker.

The three-dimensional marker 1 is thus formed after the construction of each section. In practice, this construction step can comprise a step of manufacturing the three-dimensional marker 1, for example by means of a three-dimensional printer.

The method ends with step E10 corresponding to a step of constructing the system 30 for mechanical attachment of the three-dimensional marker 1.

Here, according to a preferred embodiment, the mechanical attachment system is positioned on an apex of the three-dimensional marker 1. In practice, this apex is formed at the intersection of the faces of the precursor element 50 (and thus at the intersection of the sections).

Thus, here, this mechanical attachment system 30 is not positioned in a random manner on the three-dimensional marker 1. On the contrary, it is placed at a location making it possible to maximize the number of sections visible from the point of view of a camera positioned in front of the marker (i.e. in the axis of the attachment system), by the acquisition system of the three-dimensional marker 1 when the latter is attached on the object the three-dimensional pose is to be determined.

As an alternative, the mechanical attachment system can be positioned at another place of the three-dimensional marker, for example at the center of a section or an edge of the three-dimensional marker.

As an alternative, the precursor element can have a single face. That is for example the case of a sphere-shaped precursor element as shown in FIG. 10. In such a configuration, the surface partition comprises a plurality of parts of different sizes and shapes. In this case, the construction method described hereinabove leads to the formation of sections of the three-dimensional marker whose constitutive elements are inhomogeneous and mostly have non-regular hexahedral shapes.

According to another alternative, the two-dimensional representation values are values of a parameter of a mathematical function associated with the surface. For example, functions whose parameters are the dimensions of the respective part of the precursor element surface and the two-dimensional representation values are used. These mathematical functions are for example parts of ellipsoids or spheres.

In the case of a cube-shaped precursor element and square-shaped face parts (FIG. 11), the mathematical functions can for example depend on the side or diagonal value of each square part.

In this case, in the following of the construction method, the height change of each part of the precursor element surface then depends on the mathematical function defined by the value associated with the respective surface part in the two-dimensional representation.

More particularly, in the example of FIG. 11, the height change of each part has an ellipsoid profile in which the value of each minor axis b and c depends on the dimensions of the square parts of the precursor element faces and the value of the semi-major axis a depends on the two-dimensional representation value associated with the respective square part. In other words, in this alternative, the height (with respect to the precursor element surface) of each point of the respective part is given by the value, for this point, of a mathematical function parameterized by the value associated with the respective part in the two-dimensional representation (and possibly also by the dimensions of said respective part). Each section here comprises for example semi-spheres or semi-ellipsoids.

The three-dimensional marker as obtained at the end of the construction method finds a particular application in the surgical field, for example during location determination and tracking of surgical tools. In particular, this improves the precision of surgical procedures.

It can also be advantageously used in the field of medical imaging, to replace the optical and electromagnetic tracking tools used for spatial tracking of ultrasound probes.

1. A method for constructing a three-dimensional marker from a precursor element, said precursor element having at least one surface, said method comprising:
determining at least one two-dimensional representation associated with said at least one surface of the precursor element, said at least one two-dimensional representation comprising a plurality of values respectively associated with parts of the at least one surface of said precursor element; and
constructing a corresponding section of said three-dimensional marker from said at least one surface by setting a structural feature of a section element, among a group of section elements, of the corresponding section, defining the section element from said at least one surface, as a function of one of the values of the at least one two-dimensional representation associated with the respective part of said at least one surface.

2. The construction method according to claim 1, wherein said precursor element has a plurality of faces,
said determining the at least one two-dimensional representation comprises determining a plurality of two-dimensional representations respectively associated with at least some of said faces of the precursor element, and
said constructing comprises, for each of the faces of said precursor element associated with one of the two-dimensional representations, constructing a corresponding section of said three-dimensional marker from said face by setting the structural feature of one of the section elements of the corresponding section, defining said one of the section elements from said face, as a function of the values of the at least one two-dimensional representation, said values being respectively associated with parts of said face.

3. The construction method according to claim 2, wherein the plurality of two-dimensional representations is determined to maximize a determined distance between the two-dimensional representations associated with two juxtaposed ones of the faces of said precursor element.

4. The construction method according to claim 1, wherein said structural feature of the section element of the corresponding section is the height of the section element relative to said at least one surface.

5. The construction method according to claim 4, wherein the setting the structural feature of the corresponding section element corresponds to a height increase or a height decrease with respect to said respective part of the at least one surface of the precursor element.

6. The construction method according to claim 5, wherein the at least one two-dimensional representation comprises a series of first values and a series of second values, at least one first value being different from a second value, the height increase being associated with said series of first values and the height decrease being associated with said series of second values.

7. The construction method according to claim 5, wherein the height increase or the height decrease is implemented for a randomly-determined one of the parts of the at least one surface of the precursor element.

8. The construction method according to claim 5, wherein the three-dimensional marker is configured to cooperate with an acquisition system, the height increase or decrease depending on accuracy parameters of said acquisition system.

9. The construction method according to claim 4, wherein, each section of said three-dimensional marker being formed of a plurality of section elements, respective heights of the plurality of section elements of the at least one section are determined as a function of the different values of the two-dimensional representation, respectively.

10. The construction method according to claim 1, wherein the plurality of values of the two-dimensional representation is randomly determined.

11. The construction method according to claim 1, wherein the at least one two-dimensional representation is a matrix representation.

12. The construction method according to claim 1, wherein the at least one two-dimensional representation comprises binary values.

13. The construction method according to claim 12,
wherein said structural feature of the section element of the respective section is the height of the section element relative to said at least one surface,
wherein the setting the structural feature of the respective section element corresponds to a height increase or a height decrease with respect to said respective part of the at least one surface of the precursor element,
wherein the at least one two-dimensional representation comprises a series of first values and a series of second values, at least one first value being different from a second value, the height increase being associated with said series of first values and the height decrease being associated with said series of second values, and
wherein the first values are equal to 1 and the second values are equal to 0.

14. The construction method according to claim 1, further comprising a step of constructing a system for mechanical attachment of the three-dimensional marker.

15. The construction method according to claim 14, wherein said precursor element has a plurality of faces,
said determining the at least one two-dimensional representation comprises determining a plurality of two-dimensional representations respectively associated with at least some of said faces of the precursor element, and
said constructing comprises, for each of the faces of said precursor element associated with one of the two-dimensional representations, constructing a corresponding section of said three-dimensional marker from said face by setting the structural feature of one of the section elements of the corresponding section defining said one of the section elements from said face, as a function of the values of the at least one two-dimensional representation, said values being respectively associated with parts of said face, and
wherein the mechanical attachment system is positioned on an apex of the three-dimensional marker corresponding to the intersection of several of the faces of the precursor element.

16. A three-dimensional marker obtained by the construction method according to claim 1.

17. The construction method according to claim 14, wherein said precursor element has a plurality of faces,
said determining the at least one two-dimensional representation comprises determining a plurality of two-dimensional representations respectively associated with at least some of said faces of the precursor element,
said constructing comprises, for each of the faces of said precursor element associated with one of the two-dimensional representations, constructing a corresponding section of said three-dimensional marker from said face by setting the structural feature of one of the section elements of the corresponding section defining said one of the section elements from said face, as a function of the values of the at least one two-dimensional representation, said values being respectively associated with parts of said face,
wherein the plurality of two-dimensional representations is determined to maximize a determined distance between the two-dimensional representations associated with two juxtaposed ones of the faces of said precursor element, and
wherein the mechanical attachment system is positioned on an apex of the three-dimensional marker corresponding to the intersection of several of the faces of the precursor element.
